(19) United States
(12) Patent Application Publication
(10) Pub. No.: US 2015/0009064 A1
(43) Pub. Date: Jan. 8, 2015

(54) RADAR SENSOR

(71) Applicants: Christian WALDSCHMIDT, Renningen (DE); Dirk STEINBUCH, Wimsheim (DE); Ralk SCHNABEL, Leonberg (DE); ROBERT BOSCH GMBH, Stuttgart (DE)

(72) Inventors: Christian Waldschmidt, Renningen (DE); Dirk Steinbuch, Wimsheim (DE); Raik Schnabel, Leonberg (DE)

(73) Assignee: ROBERT BOSCH GMBH, Stuttgart, DE (DE)

(21) Appl. No.: 14/377,757

(22) PCT Filed: Dec. 17, 2012
(86) PCT No.: PCT/EP2012/075755

§ 371 Date: Aug. 8, 2014

(30) Foreign Application Priority Data
Feb. 10, 2012 (DE) 10 2012 202 007.1

(51) Int. Cl. G01S 7/02; G01S 13/02

(52) U.S. Cl. CPC G01S 7/02; G01S 13/02
USPC 342/175

(57) ABSTRACT

A radar sensor includes: an oscillator for generating a transmission signal; a mixer for generating an intermediate-frequency signal by mixing a part of the transmission signal with a received signal; and an offset-compensation unit for generating an oscillating compensation signal, which is sent to the mixer in addition to the aforementioned part of the transmission signal.

### BACKGROUND OF THE INVENTION

1. Field of the Invention

The present invention relates to a radar sensor, in particular a radar sensor for motor vehicles, including an oscillator for generating a transmission signal and a mixer for generating an intermediate-frequency signal by mixing a part of the transmission signal with a received signal.

2. Description of the Related Art

Radar sensors are used in motor vehicles to detect the surroundings of the vehicle, for example, and to locate preceding vehicles. For example, there are known driver assistance systems, which include a radar sensor and have comfort functions, for example, a cruise control and/or an adaptive cruise control (ACC) system.

Transmitting and receiving antennas of a radar sensor are usually situated behind a cover, which is also referred to as a radome, and/or a radar lens. The transmission signal is emitted via a transmitting antenna, and a received signal is received by a receiving antenna. Separate transmitting and receiving antennas or a shared transmitting/receiving antenna may be used. The received signal is mixed down by mixing with part of the transmission signal to yield an intermediate-frequency signal or a baseband signal. The intermediate-frequency signal of the radar sensor or of any channel of the radar sensor is usually amplified by an amplifier in an evaluation circuit and sent to an analog/digital converter.

In FMCW (frequency-modulated continuous-wave) radar, the transmission signal is frequency modulated, for example, according to one or more modulation ramps. Information about the distance and relative speed of a radar object reflecting the transmitted signal may be obtained from the intermediate-frequency signal, based on the received signal, by a method familiar to those skilled in the art. The distance of the radar object over the transmit time of the radar signal enters into the received signal and causes a frequency difference between the received signal and the transmission signal emitted at the same time according to the more advanced modulation ramp characteristic. The relative speed of the radar object causes a corresponding Doppler shift in the reflected radar signal.

Radar objects at a small distance from the radar sensor may result in received signals whose frequency deviates only slightly from the transmission signal. It is therefore desirable to also evaluate the intermediate-frequency signal in the range of low frequencies.

However, it may happen, due to reflections of the transmission signal directly at the radar sensor or its cover, that the received signal has a frequency component equal to the transmission frequency. At the output of the mixer, this results in a direct voltage component (DC offset) of the intermediate-frequency signal. Crosstalk within the circuit of the radar sensor between the transmission branch and the reception branch and/or among multiple channels of the radar sensor may result in a direct voltage component of the intermediate-frequency signal occurring due to the mixing of signal components having the same frequency. Such a direct voltage component of the intermediate-frequency signal is unwanted since it may mask the low frequency signal components of the intermediate-frequency signal and therefore nearby radar objects may not be reliably detected, for example.

DE 10 2010 002 800 A1 describes a radar sensor with which an adjustable phase-shift element is switched between a local oscillator for generating the transmission signal and a mixer to supply a signal, which has been phase-shifted with respect to the transmission signal, to the mixer. An evaluation unit for the intermediate-frequency signal includes an adder, which adds an offset-compensation direct voltage to the intermediate-frequency signal before the sum is supplied to an intermediate-frequency amplifier having an adjustable gain factor. The output of the intermediate-frequency amplifier forms the input signal for an analog/digital converter. Suitable values for the phase shift, the gain factor and the offset-correction voltage are ascertained by measuring the direct voltage component of the intermediate-frequency signal without an offset-correction voltage by running through a parameter range of the phase shift at a fixed oscillator frequency and ascertaining a curve range having a preferably low variation in the direct voltage component. By adjusting a phase shift, which shifts the curve range ascertained into a frequency interval provided for operation, the frequency dependence of the direct voltage component is altered in such a way that the variation in the direct voltage component becomes low within the frequency interval used. The parameter for the offset-compensation voltage may also be established on the basis of the measured curve.

According to the related art, a direct voltage component of the intermediate-frequency signal may be compensated by adding a compensation direct voltage to the intermediate-frequency signal. One disadvantage here is the load on the mixer due to the occurrence of the unwanted direct voltage component, so that degradation of the mixer may occur. Degradation of the mixer may also occur in the event of a compensation direct voltage being fed into the mixer. The power and thus the reliability of the radar sensor may be impaired due to a degradation of the mixer caused by the direct voltage component.

### BRIEF SUMMARY OF THE INVENTION

The object of the present invention is to create a novel radar sensor, which will permit a preferably great reliability of the mixer and good evaluability of the intermediate-frequency signal.

This object is achieved according to the present invention by a radar sensor of the type defined at the outset due to an offset-compensation unit for generating an oscillating compensation signal, which is supplied to the mixer in addition to the aforementioned part of the transmission signal. This makes it possible to reduce the direct voltage component of the intermediate-frequency signal generated by the mixer.

An interfering signal component, which would otherwise result in a direct voltage component of the intermediate-frequency signal at the output of the mixer, may already be compensated at the mixer or at the input side upstream from the mixer by supplying an oscillating compensation signal during transmission operation, this signal oscillating at the frequency of an interfering signal component of the received signal, for example. This may reduce the load on the mixer. For example, the compensation signal oscillates at the frequency of the transmission signal. It is coupled to the transmission signal, for example.

The compensation signal and the received signal are sent to the mixer. The oscillating compensation signal is preferably sent to the mixer by supplying it in the reception path upstream from the mixer. For example, the oscillating condensation signal may be added to the received signal before the received signal is sent, together with the oscillating compensation signal, to the mixer. However, the oscillating compensation signal may also be supplied directly at the mixer, preferably at a feed-in point near the feed-in point for the received signal.

The radar sensor preferably includes a sensor for measuring a direct voltage component of an intermediate-frequency signal and at least one control circuit for regulating an amplitude, a power and/or a phase angle of the oscillating compensation signal as a function of a measured direct voltage component of the intermediate-frequency signal. Thus, at least one of the aforementioned parameters of the compensation signal may be re-regulated to minimize the direct voltage component of the intermediate-frequency signal in this way while running through a modulation ramp of an FMCW radar sensor, for example.

This object is further achieved by a method for operating a radar sensor, in which an oscillator generates a transmission signal and a mixer mixes a part of the transmission signal with a received signal, characterized in that an oscillating signal is supplied to the mixer in addition to that part of the transmission signal, so that a direct voltage component of an intermediate-frequency signal generated by the mixer is reduced. This means that the direct voltage component is smaller than it would be without the oscillating signal being supplied.

### BRIEF DESCRIPTION OF THE DRAWINGS

FIG. 1 shows a block diagram of a radar sensor according to the present invention.

FIG. 2 shows a control circuit of the radar sensor.

FIG. 3 shows a schematic block diagram of a multichannel radar sensor.

FIG. 4 shows a variant of the radar sensor according to FIG. 1.

### DETAILED DESCRIPTION OF THE INVENTION

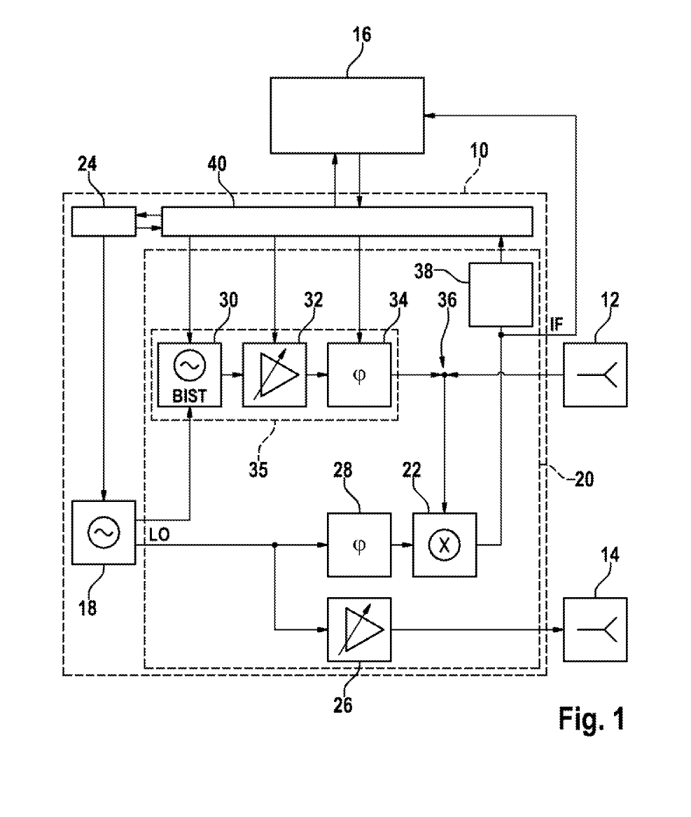

FIG. 1 shows an FMCW radar sensor for motor vehicles including a monolithic microwave integrated circuit (MMIC) 10 and antenna elements 12, 14 for receiving and transmitting radar signals. The radar sensor is connected to an evaluation circuit 16 for evaluating intermediate-frequency signals IF (intermediate frequency) of the radar sensor.

MMIC 10 includes a local voltage-controlled oscillator (VCO) 18 for generating a radar transmission signal or an LO (local oscillator) signal and at least one transmission/reception channel 20, which is connected to at least one receiving antenna element 12 and at least one transmitting antenna element 14 and includes a mixer 22 for generating an intermediate-frequency signal IF from a radar received signal.

The working frequency of oscillator 18 is approximately 77 GHz and is controlled by a modulation unit 24, for example. Modulation unit 24 is configured, for example, to control the oscillation frequency of oscillator 18 and thus the frequency of the LO signal according to a modulation scheme, which includes at least one frequency ramp.

The LO signal generated by oscillator 18 is supplied to transmitting antenna element 14 via an optional buffer amplifier 26. A part of the LO signal is sent to mixer 22.

The radar signal received by receiving antenna element 12 is also sent to mixer 22 and mixed with the diverted part of the transmission signal in a manner known per se to generate intermediate-frequency signal IF. Intermediate-frequency signal IF is sent to an input of evaluation circuit 16.

Optionally, the part of the LO signal supplied to mixer 22 is phase shifted with respect to the transmission signal by a phase shifter 28.

Radar sensor 10 and evaluation circuit 16 may be part of a driver assistance system, for example.

Radar sensor 10 has at least one channel 20, preferably multiple channels, for example, four channels 20. The LO signal of oscillator 18 is sent to each channel 20. Another output of oscillator 18 is connected to channels 20 to make available a “test” reference signal to channels 20. For example, a part of the LO signal of oscillator 18 is decoupled for this purpose. The frequency of the reference signal corresponds to the frequency of the LO signal. The reference signal may be coupled to the LO signal, for example.

Channel 20 optionally includes a signal generator 30, which is configured to generate an oscillating compensation signal. In the example shown here, the compensation signal is generated based on the supplied “test” reference signal. The compensation signal is suppliable to the received signal input of mixer 22 via a controllable buffer amplifier 32 and a controllable phase shifter 34. For example, channel 20 includes a switching point 36, which is at a distance from mixer 22, at which the compensation signal made available at the output of phase shifter 34 is combined with or added to the received signal, received by receiving antenna element 12, and then sent together with the received signal to a feed-in point of mixer 22.

Signal generator 30 may be formed by a modulator or an oscillator coupled to the reference signal, for example. While in the transmission operating mode of radar sensor 10 described here, signal generator 30 of channel 20 generates the oscillating compensation signal, in a self-test mode of radar sensor 10, for example, signal generator 30 may generate a test signal for simulating the reception case based on a reference signal. Signal generator 30 may thus assume multiple functions.

The oscillating compensation signal may also be made available, for example, in one exemplary embodiment having an offset-compensation unit without a signal generator 30, by decoupling from the “test” reference signal or from the LO signal via buffer amplifier 32 and phase shifter 34, or the “test” reference signal itself may be made available as an oscillating compensation signal via buffer amplifier 32 and phase shifter 34 of the offset-compensation unit.

The adjustable amplification of buffer amplifier 32 and the phase angle of the compensation signal, which is adjustable by phase shifter 34, make it possible to generate a compensation signal, with which the direct voltage component of intermediate-frequency signal IF occurring at the output of mixer 22 may be minimized. Signal generator 30, buffer amplifier 32 and phase shifter 34 thus form an offset-compensation unit 35 for at least partially compensating a direct voltage component of intermediate-frequency signal IF. Since the compensation signal is fed in upstream from the feed-in point of mixer 22 in the reception path, mixer 22 is effectively relieved of the occurring direct voltage components. Degradation of mixer 22 caused by a DC current load is therefore largely preventable. In particular, the compensation signal may be counteracted with respect to its phase angle and amplitude opposite an unwanted interference signal of the same frequency in the received signal and may thus compensate the interference signal.

Radar sensor 10 includes a sensor 38 for detecting a direct voltage component of intermediate-frequency signal IF at the output of mixer 22. An output value of sensor 38, which depends on the direct voltage component, is sent to a control unit 40. Control unit 40 is connected to buffer amplifier 32, phase shifter 34 and optionally to signal generator 30 of offset-compensation unit 35 to trigger these as a function of the direct voltage component measured by sensor 38.

Similarly, sensor 38 may measure the direct voltage component, for example, by measuring the direct voltage-coupled intermediate-frequency signal IF. However, sensor 38 may also be configured to digitize the intermediate-frequency signal and to determine the direct voltage component on the basis of the digitized intermediate-frequency signal. For example, sensor 38 may include an A/D converter. The direct voltage component may be determined by Fourier transform, in particular by forming the fast Fourier transform (FFT), on the basis of the digitized intermediate-frequency signal, for example.

Control unit 40 may be configured to control the amplitude, the power and/or the phase angle of the compensation signal, based on measured direct voltage component 38, and optionally also based on the frequency of the LO signal or of the “test” reference signal. For example, a signal characterizing the frequency of the corresponding signal may be sent to control unit 40 from modulation device 24, for example.

The parameters of the compensation signal selected to minimize the direct voltage component at a given signal frequency, for example, the amplitude and phase angle, may be determined, for example, by test measurements by adjusting different parameter values during operation of the radar sensor at regular intervals and measuring the resulting direct voltage component of intermediate-frequency signal IF. Deviations both up and down in the prevailing parameter values within a small vicinity around the prevailing parameter values may be used in particular as a test for generating the compensation signal, and the parameter values having the smallest measured direct voltage component of intermediate-frequency signal IF are established as new parameter values for further operation of the radar sensor. In this way, an adaptive tracking of the parameter values may take place when the interference signals occurring in the reception branch undergo changes over a period of time.

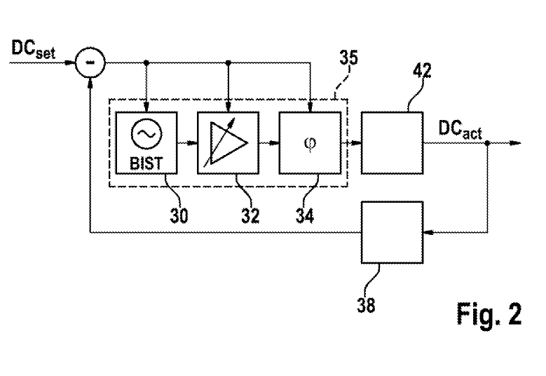

FIG. 2 schematically shows a control circuit for the compensation signal. Sensor 38, control unit 40 and offset-compensation unit 35 form a control circuit to regulate measured direct voltage component DC_{act} of intermediate-frequency signal IF of a channel 20 to a preferably low setpoint value DCₛₑₜ, for example, DCₛₑₜ=0. This is schematically illustrated in FIG. 2, where a transfer zone 42 symbolizes send-and-receive channel 20, including potential interference signal sources.

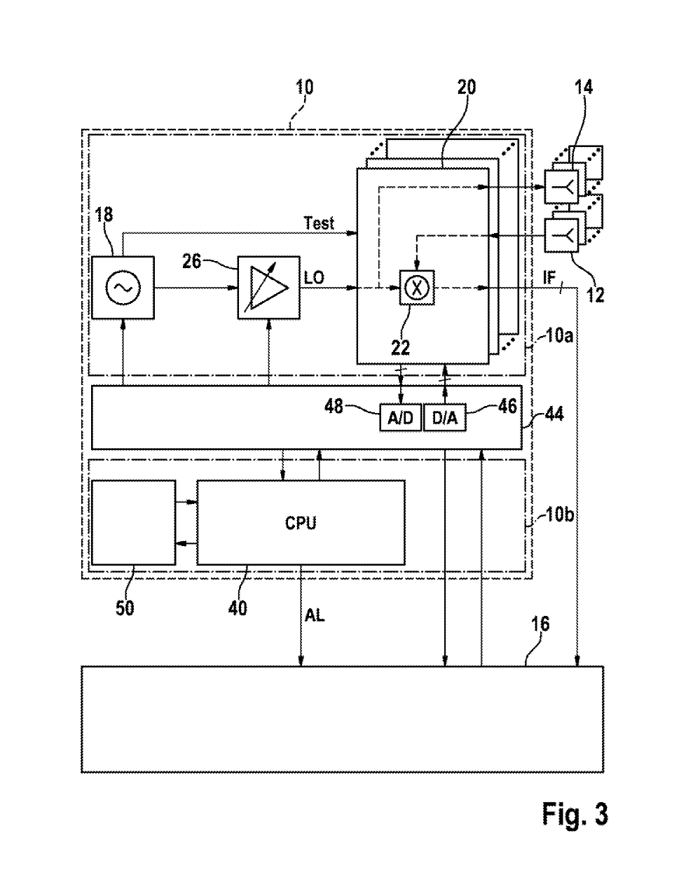

In the example of the radar sensor according to FIG. 1, shown in FIG. 3, with multiple channels 20, MMIC 10 includes an analog circuit part 10a, a digital circuit part 10b and an interface 44 for triggering analog circuit part 10a and for communication with digital circuit part 10b. Analog circuit part 10a includes oscillator 18 and channels 20. The transmission signal is sent to channels 20 via an optional buffer amplifier 26. Digital circuit part 10b includes control unit 40, which may be formed by a digital program-controlled processing unit or CPU (central processing unit), for example.

Interface 44 includes, for example, at least one D/A converter 46 for triggering oscillator 18, signal generator 30, buffer amplifier 32 and/or phase shifter 34 of offset-compensation unit 35 of each channel 20. In addition, interface 44 includes, for example, at least one A/D converter for digitizing the output signal of sensor 38 of respective channel 20.

The processing unit may be configured to control additional functions of the radar sensor, in particular MMIC 10. The processing unit may also assume, for example, the function of modulation unit 24 in addition to the function of control unit 40. Control unit 40 may access an optional nonvolatile memory 50 for storing a parameter value of offset-compensation unit 35. For example, the prevailing aforementioned parameter values of the compensation signal may be stored in memory 50, so that they are available again, even after a temporary shutdown of the radar sensor.

Control unit 40 is optionally configured to output an alarm signal AL when control unit 40 detects degradation of corresponding mixer 22 on the basis of exceeding a limiting value for the measured direct voltage component of intermediate-frequency signal IF. Alarm signal AL may be sent to evaluation circuit 16, for example, via an interrupt input. Monitoring of offset-compensation unit 35 integrated into MMIC 10 may take place in this way, so that the reliability of the radar sensor is further increased. The reliability of the evaluation of the received radar signals is thus improved. Thus, on the whole, not only is it possible to largely prevent degradation of mixer 22 through offset-compensation unit 35, but also an improved fault detection is possible through rapid MMIC-internal detection of an inadmissibly high direct voltage component. Both contribute to improved system reliability of the radar sensor.

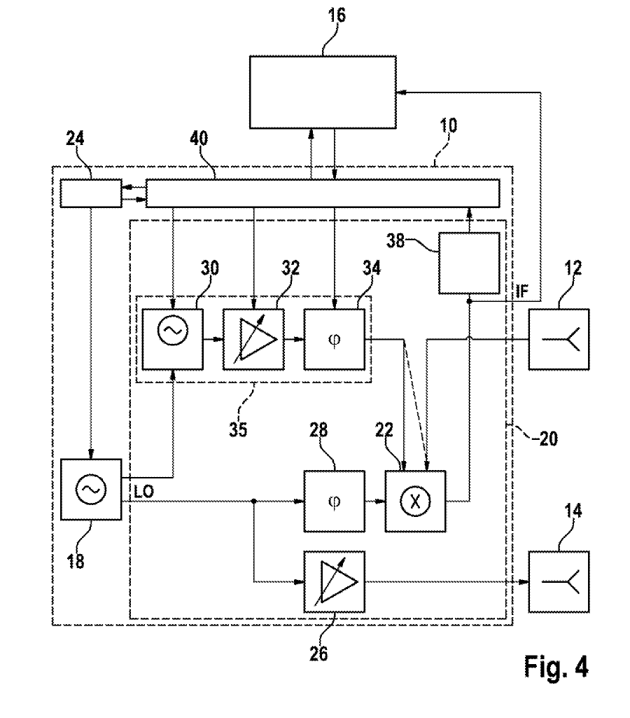

FIG. 4 shows a variant of the radar sensor according to

FIG. 1. Corresponding components are labeled with the same reference numerals. While in the example in FIG. 1, the received signal and the compensation signal are combined at switching point 36 and sent together to mixer 22 at a feed-in point, in the example in FIG. 4, the received signal and the compensation signal are each sent directly to mixer 22 at the adjacent feed-in points or at a shared feed-in point (shown with dotted lines).

1-11. (canceled)

12. A radar sensor, comprising:
an oscillator generating a transmission signal;
a mixer generating an intermediate-frequency signal by mixing a selected part of the transmission signal with a received signal; and
an offset-compensation unit generating an oscillating compensation signal which is sent to the mixer along with the selected part of the transmission signal.

13. The radar sensor as recited in claim 12, wherein the oscillating compensation signal is sent to the mixer by being fed into a reception path upstream from the mixer.

14. The radar sensor as recited in claim 13, further comprising:
a control unit adjusting at least one of an amplitude, a power and a phase angle of the oscillating compensation signal.

15. The radar sensor as recited in claim 14, further comprising:
a sensor measuring a direct voltage component of the intermediate-frequency signal.

16. The radar sensor as recited in claim 15, wherein the control unit adjusts the at least one of the amplitude, the power, and the phase angle of the oscillating compensation signal based on the measured direct voltage component of the intermediate-frequency signal.

17. The radar sensor as recited in claim 16, wherein:
a monolithic integrated microwave circuit includes the oscillator, the mixer, the at least one sensor measuring a direct voltage component of the intermediate-frequency signal, the offset-compensation unit, and the control unit; and
the control unit triggers the offset-compensation unit as a function of the direct voltage component of the intermediate-frequency signal measured by the sensor, for adjusting the at least one of the amplitude, the power, and the phase angle of the oscillating compensation signal.

18. The radar sensor as recited in claim 16, wherein the control unit is formed by at least one part of a digital program control processing unit.

19. The radar sensor as recited in claim 17, wherein the monolithic integrated microwave circuit includes at least one nonvolatile memory storing a parameter value of the offset-compensation unit.

20. The radar sensor as recited in claim 16, wherein the control unit outputs an alarm signal when the direct voltage component of the intermediate-frequency signal measured by the sensor exceeds a limiting value.

21. A method for operating a radar sensor, comprising:
generating, by an oscillator, a transmission signal;
mixing, by a mixer, a part of the transmission signal with a received signal; and
reducing a direct voltage component of an intermediate-frequency signal generated by the mixer, by supplying an oscillating compensation signal to the mixer.
